(19) United States
(12) Patent Application Publication
(10) Pub. No.: US 2009/0119232 A1
(43) Pub. Date: May 7, 2009

(54) Parcel franking device and method using same

(75) Inventors: Antoine Mercier, Montmorency (FR); Florence Hirel, Chatillon (FR)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: E-BOX SARL, Paris (FR)

(21) Appl. No.: 10/578,958

(22) PCT Filed: Jan. 3, 2005
(86) PCT No.: PCT/FR2005/000002

§ 371 Date: Dec. 3, 2008

(30) Foreign Application Priority Data
Jan. 8, 2004 (FR) 0400133

(51) Int. Cl. G07F 17/26

(52) U.S. Cl. 705/407

(57) ABSTRACT

Parcel-franking apparatus which comprises: a plurality of lockers (2) provided with respective doors (3); a management unit (11); locks (4) each adapted to lock a respective door and under individual control individually; door position detectors (5) adapted to inform the management unit when the corresponding doors are closed; a weight sensor (9a, 9b) adapted to transmit to the management unit an indication of the weight of a parcel placed in a locker; and data input means (14). The management unit (11) is adapted to act, when a position detector (5) of a door of a locker detects that the door is closed: to compute a franking price for franking a parcel placed in this determined locker on the basis of the data delivered and of the indication of the weight of the parcel;
to cause the door of said locker to be locked; and
to keep the door of said locker locked until a parcel retrieval code is recognized.

The present invention relates to franking apparatus for franking parcels, and more particularly to franking apparatus making it possible for users themselves to perform the franking operations.

It is known in post offices to place apparatus comprising a weighing scale on which the user places the parcel, means for computing the franking price as a function of the measured weight, payment means, and print means for printing a franking label.

Once the payment has been made, the label is printed, the user sticks the printed label on the parcel, and removes the parcel from the scales so as to deposit it in a mailbox which is usually constituted merely by a bin accessible via a hole formed in one of the walls of the public area.

With that type of apparatus, it is not necessary to call upon the services of a counter clerk or “teller”, but it is open to fraud because the weighing scales are accessible during the weighing operation. In addition, it requires a safe place to be present in which the users can deposit their parcels. Therefore, that type of apparatus is generally installed in the public area of a post office and use of it is limited to the opening hours of the post office, so that it can be watched over by the post office staff.

In addition, Document EP-A-643 374 discloses an automatic franking system. That system includes a weighing unit placed in a housing inside the system and access to that housing is prevented during the franking operation by an electromechanically controlled door. Once the payment has been made by the user, a print unit marks the parcel, and then a handling device moves the parcel so as to make it fall into one or other of the receptacles provided under weighing unit.

The fact that the parcel is handled by the franking machine is a source of drawbacks. The parcel might be damaged on falling, or on receiving another parcel. It might also jam in the handling device, thereby putting the system out of order.

It should also be noted that that system is particularly costly and complex due to the need to provide a large number of electromechanical actuators.

An object of the invention is to provide franking apparatus that can be used in stand-alone and reliable manner, i.e. while guaranteeing, in particular that the parcels are not damaged during the franking operation.

To this end, the present invention provides parcel-franking apparatus, characterized in that it comprises:

a plurality of lockers designed to contain parcels and each provided with a door;

a management unit;

locks each adapted to lock a respective door and each controlled individually by the management unit;

door position detectors, each associated with a respective door and adapted to inform the management unit when the corresponding door is closed;

at least one weight sensor adapted to transmit to the management unit an indication of the weight of a parcel placed in one or other of the lockers; and

display means, data input means, and payment means, all these means being connected to the management unit;

and in that the management unit is adapted:

to compute a franking price for franking a parcel placed in a determined locker on the basis of the data delivered by the input means, and of the indication of the weight of said parcel as transmitted by the weight sensor, when a position detector associated with a door of said determined locker detects that the door is closed;

to cause the door of said locker to be locked once the computed franking price has been paid; and

to keep the door of said locker locked until the management unit recognizes a parcel retrieval code which has been delivered to it by the data input means.

Thus, the parcel does not undergo any handling that might damage it from the time at which it is deposited in the locker by the user to the time at which it is retrieved by an employee of a shipping company. In addition, the absence of handling means simplifies the construction of the franking apparatus and reduces the risks of said apparatus being out of order.

It should be noted that by waiting for information indicating that the door is closed before computing the franking price, the possibilities for fraud are reduced considerably.

In addition, the mere fact that a parcel is contained in a locked locker means that the franking price of that parcel has been paid, so that it is not necessary to mark the parcel as soon as it its deposited in the locker in order to indicate physically on it that it has been correctly franked. Naturally however, it is quite possible to affix a label to the parcel subsequently, in particular at the time at which it is retrieved, in order to track its shipment.

In addition, the fact that the door of the locker is locked only once payment has been made enables the user to retrieve the parcel before that step and thus increases the user's trust in the franking apparatus.

In preferred embodiments of the franking apparatus, use is made, in addition, to one or more of the following provisions:

the management unit includes memory means adapted to store tables of franking rates corresponding to various types of destinations and/or to various types of shipping services, the management unit being adapted to compute the franking price by means of a rate selected from the data delivered by the input means, so that the user has a wide choice of destinations and of types of services, such as, for example, normal rate or express rate;

the management unit includes memory means adapted to store a plurality of predetermined shipping companies and a table associating a determined locker with a predefined shipping company, the management unit being adapted to record the association of a particular locker with a predefined shipping company on the basis of the data delivered by the input means, so that use of the apparatus can be shared in pooled manner by a plurality of shipping companies;

the management unit is adapted to cause the doors of all of the lockers associated with a predefined shipping company to be unlocked, once a retrieval code transmitted by the data input means has been recognized.

The present invention also provides a method of implementing parcel-franking apparatus as defined above, said method comprising a franking operation, in which method the franking operation comprises the following steps:

waiting for information indicating that the door of a determined locker is closed; then

computing a franking price for franking a parcel placed in said determined locker on the basis of the data delivered to the input means and by means of the indication of the weight of said parcel as transmitted by the weight sensor;

paying the franking price as previously computed; and

locking the door of said determined locker.

In preferred methods of implementing the franking apparatus, use is also made of one or more of the following provisions:

prior to the step of waiting for a closed signal, the franking operation further comprises:

selecting the determined locker from among the available lockers by the management unit; then

unlocking the lock of said determined locker by the management unit;

providing the management unit with memory means adapted to store tables of franking rates corresponding to different types of destination and/or to different types of shipping services, and the computing step of the franking operation further comprises at least one of the following sub-steps:

displaying various types of destination stored by the management unit, followed by using the input means to select a type of destination, and applying the corresponding franking rate to computation of the franking price; and

displaying various types of destination stored by the management unit, followed by using the input means to select a type of shipping service and applying the corresponding franking rate to computation of the franking price;

providing the management unit with memory means adapted to store a plurality of predefined shipping companies and a table associating a determined locker with a predefined shipping company, and the franking operation further comprises the following step:

displaying various predefined shipping companies, followed by using the input means to select a predefined shipping company, and associating said company with the determined locker;

the franking operation further comprises, between the waiting step for waiting for information indicating that the door of the determined locker is closed and the locking step for locking said door that follows the payment step for paying for the franking price, a step consisting in interrupting the franking operation in the event that the position detector issues information indicating that said door is open;

providing the management unit with memory means which are adapted to store a table associating at least one locker with at least one predefined shipping company, and further comprising a retrieval operation for retrieving at least one parcel, said retrieval operation comprising the following steps:

recognizing a retrieval code associated with the predefined shipping company by the management unit; and

opening said at least one locker associated with said shipping company.

the retrieval operation further comprises, after the recognition step for recognizing a retrieval code, a step of printing at least one franking label for the parcel contained in said at least one locker;

the contents of a plurality of lockers are associated with the same shipping company, and, the retrieval operation for retrieving the parcels further comprises, after the recognition step for recognizing a code associated with said shipping company, the following steps:

unlocking the door of a first one of said lockers;

waiting for information indicating that the door of the first one of said lockers is in the open position; followed by:

waiting for information indicating that the door of said first one of said lockers is closed; then

unlocking the door of a second one of said lockers;

the contents of a plurality of lockers are associated with the same shipping company, and the retrieval operation for retrieving the parcels further comprises, after the recognition step for recognizing a code associated with said shipping company, the following steps:

unlocking the door of a first one of said lockers;

waiting for the weight sensor to transmit a weight indication indicating that the weight of the contents of the first one of said lockers is substantially zero; then

unlocking the door of a second one of said lockers.

Other characteristics and advantages of the invention appear from the following description given by way of non-limiting example and with reference to the accompanying drawings, in which:

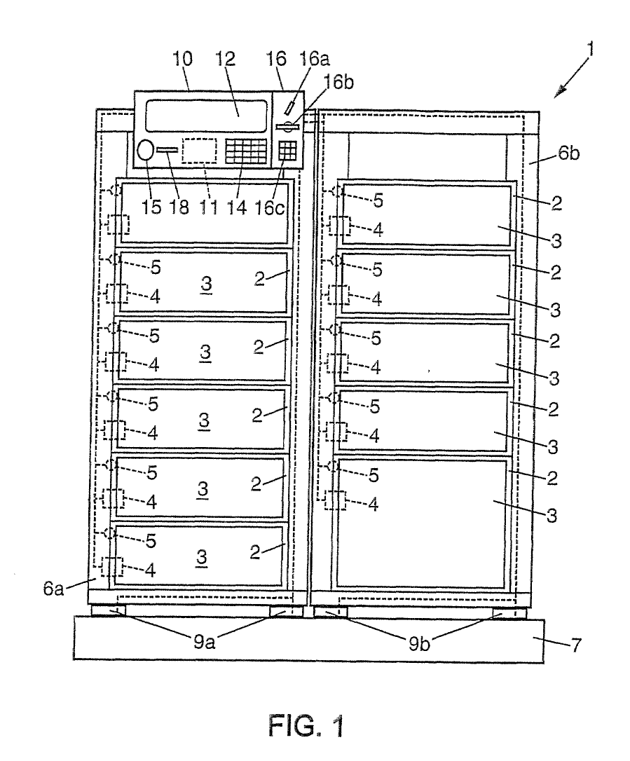

FIG. 1 is a diagrammatic front view of franking apparatus of the invention; and

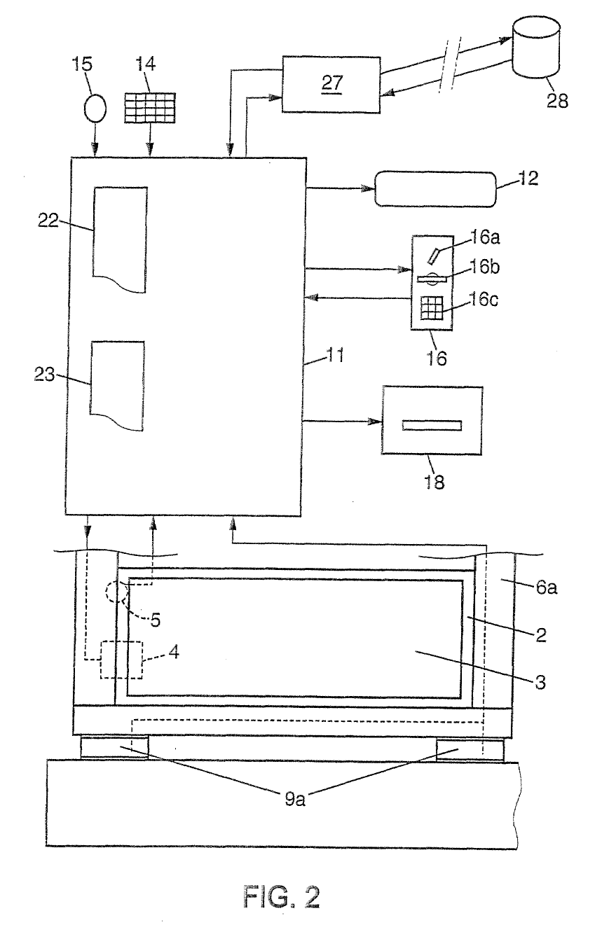

FIG. 2 is an organization chart diagrammatically showing the means implemented in the franking apparatus shown in FIG. 1.

In the figures, like references are used to designate elements that are identical or similar.

FIG. 1 shows franking apparatus comprising a plurality of lockers 2. The lockers 2, which can be of various dimensions, are designed to contain parcels or letters. Each locker 2 is provided with a door 3 which can be held closed by a lock 4.

The lock 4 is electromechanical and, in known manner, includes a keeper that can be moved by an electromagnetic device (not shown) so that the lock can go from a locked position in which the door 3 is held closed, to an unlocked position in which the door 3 is free to be moved manually or automatically to an open position. The lock 4 is caused to go from the locked position to the unlocked position electrically by receiving an opening instruction that can be in the form of a current pulse.

Each locker 2 is also provided with a position detector 5 which sends an electrical signal when the corresponding door is closed. The detector 5 is also adapted to send a signal indicating that the door is open if said door is ajar.

The position detector 5 can be implemented simply in the form of an electrical contactor that prevents current from passing when the door is closed and that conducts when the door is in the ajar position. Naturally however, the position detector can be implemented differently, and, in particular, it can send a first encoded message when the door is closed and a second encoded message as soon as the door is ajar. It is also possible to use a plurality of electrical contactors for implementing the position detector for the door.

The door 3 of a locker can be implemented in the form of a metal plate mounted to pivot on hinges, or indeed it can also be implemented in the form of a sliding curtain as described in the French patent application filed under the number FR 0212921 on Oct. 17, 2002.

In the embodiment shown, the lockers in each column are mounted removably in a corresponding frame (6a, 6b), the weight sensors (9a, 9b) being interposed between each of the frames and a base 7. Naturally however, the weight sensors can be implemented differently, for example, a strain gauge can be used that is sensitive to the deformations of a crosspiece bearing the weight of the lockers, said lockers being mounted to slide between the vertical uprights of the frames (6a, 6b).

For fuller details concerning implementation of the sensors (9a, 9b), reference can be made to French Patent Application FR 0301767 filed on Feb. 17, 2003.

The parcel deposit apparatus also includes a control panel 10 in which a management unit 11 is arranged.

The management unit 11 can be implemented by a microprocessor or by any other data-processing means suitably programmed to perform the operations that are described in detail below.

The management unit 11 is connected electrically to the electromechanical locks 4, and it is adapted to cause one or other of the locks to be locked or unlocked.

The management unit 11 is also connected, electrically or otherwise, to the position detectors 5 and to the weight sensors (9a, 9b) so that it can process the signals delivered by one of the position detectors (5) or a weight indication transmitted by one of the weight sensors (9a, 9b). The processing of the signals delivered by the detectors 5 makes it possible for the management unit (11) to deduce information indicating whether one or other of the doors is closed or is open.

The control panel 10 also includes a display screen 12, data input means (14, 15), payment means 16, and print means 18.

The screen 12 is connected to the management unit 11 so as to display messages issued thereby, in particular so as to dialogue with a user who wishes to frank a parcel.

In the embodiment shown, the data input means comprise an alphanumeric keypad 14 which makes it possible for the user to input information such as, for example, a country of destination, and to make choices from among various proposals displayed on the screen. The data input means further comprise a barcode reader 15 which makes it possible, in particular, for a shipping company to input rapidly and reliably a retrieval code when said company comes to fetch the parcels that it is to pick up. It is clear to the person skilled in the art that the barcode reader 15 can be replaced by any known identification means, such as, for example an electromagnetic loop adapted to set up dialogue with a carrier used by the shipping company, or indeed biometric data recognition means.

Naturally, the data input means 14, 15 are connected to the management unit 11 so that said management unit 11 can process the received data.

In the embodiment shown, the payment means 16 comprise a coin-operated mechanism 16a, a smart card reader 16b, and a numeric keypad 16c which makes it possible for the user to input the identity code associated with the smart card of the user. Naturally, the payment means can include other devices, such as, for example, a banknote reader or a magnetic card reader.

The payment means 16 are connected to the management unit 11 in both-way manner, so as firstly to request payment of a sum pre-computed by the management unit 11, and secondly so as to indicate to the management unit 11 that the payment has been made.

The print means 18, controlled by the management unit 11, comprise a printer, a roll of paper, and means for advancing and cutting the roll so as to issue a ticket to the outside of the franking apparatus, as is known in automatic teller machines.

The management unit 11 is adapted to compute a franking price or postage amount for a parcel placed in a determined locker chosen from the set of available lockers of the apparatus. Computation of the franking price takes account of the weight indication transmitted by the weight sensor (9a or 9b) and corresponding to the weight of the contents of said determined locker. However, such computation is performed by the management unit only when the position detector 5 of the door of the corresponding locker detects that said door is closed, in order to avoid fraud during the weighing operation. It should be noted that, for security reasons, it is preferable to keep all of the doors 3 of the lockers in the locked positions except, naturally, for the door of the locker in which the user is performing a franking operation.

Once the franking price has been computed, the management unit 11 transmits the resulting sum to the payment means 16, said payment means sending a signal back to the management unit once the required sum has been paid in full.

Immediately after receiving the message indicating that payment has been made, the management unit causes the door of the locker in question to be locked. The contents of said locker are then considered as being correctly franked by the franking apparatus.

The management unit 11 is adapted then to keep the door 3 of said locker locked until a retrieval code for retrieving said parcel, and any other parcels, is recognized, said code having been delivered to the management unit by the barcode reader means 15.

Computing the franking price can take account of other parameters in addition to the weight of the parcel. To this end, the management unit 11 includes memory means 22 containing tables that give the various franking rates, with which various types of destination are associated, e.g. local destination, national destination, or to a particular country. It is also possible to associate the various franking rates with various types of shipping services, such as normal shipping, shipping with recorded delivery, or express shipping.

The management unit 11 has memory means 23 adapted to store information relating to a plurality of predefined shipping companies, and containing one or more tables that make it possible to associate the contents of a determined locker with one or other of the predefined shipping companies. In which case, the management unit is adapted to record the association between a particular locker and one of the predefined shipping companies during the franking operation.

The various franking parameters, such as the type of destination, the type of service, or the choice of a particular shipping company, can be proposed during the franking operation by means of the display screen 12, and selected by the user using the data input means 14.

Once the franking operation has been performed, the print means 18 deliver a ticket to the user, thereby confirming that the parcel has been franked. The ticket can bear information relating to the payment, to the destination, to the type of service, to the weight of the parcel, to the location of the locker containing the parcel, or to other subjects.

The franking apparatus also includes communications means 27 connected to the management unit 11. The communications means are adapted to establish a link with a remote site 28, either at the request of the management unit, or at the initiative of the remote site. The communications means 27 are constituted by a modem adapted to set up a call via the Internet using a secure protocol. Naturally however, other communications means or networks can be implemented.

The management unit 11 is adapted to transmit information relating to the franking operations performed. It communicates in particular to the remote site the number of lockers containing parcels, and the shipping company that is to fetch each parcel, if the remote site 28 is managed by a third party company on behalf of a plurality of shipping companies, or merely the number of lockers containing parcels to be fetched by a particular shipping company if the remote site 28 is managed by said particular company.

This communication operation is performed at the initiative of the management unit 11, either after a parcel has been franked, or periodically. Naturally however, it is possible for the management unit to be interrogated via the communications means 27 by the remote site 28 at the initiative thereof.

The management unit 11 is preferably adapted to cause the doors of all of the lockers associated with a predefined shipping company to be unlocked after a single retrieval code corresponding to the predefined shipping company has been recognized, so as to limit the number of locker opening instructions when an employee of the shipping company comes to retrieve the franked parcels. The entire set of lockers can be caused to be opened almost simultaneously, but, for security reasons, in particular if the apparatus is accessible to the public during the parcel retrieval operation, it is preferable to cause the doors to open automatically but successively, using one or other of the methods that are described in detail below.

Implementing the parcel franking apparatus of the invention comprises three main types of operation, namely franking operations, communications operations for communicating with a remote site, and retrieval operations.

A user who wishes to frank a parcel presses on one of the keys of the data input means 14 so as to initiate a franking operation. During initiation of this franking operation, the management unit 11 selects an available locker from among a plurality of lockers of the apparatus, and causes the lock 4 associated with the selected locker to go to the unlocked position. It is possible during this initialization step to ask the user for an indication of the size of the parcel in order to choose a locker of suitable dimensions.

The selected locker 2 can be indicated to the user by its door 3 being automatically opened, it being understood that all of the doors are normally kept locked for security reasons, or indeed by a message being displayed that makes it possible to identify the locker.

The user places the parcel in the selected locker and manually closes the door thereof so that the position detector 5 informs the management unit 11 that the door of the locker 2 is closed. If the door is not closed, the management unit displays a message and prevents the franking procedure from continuing.

Once the door is closed, the management unit 11 optionally proposes, via the display screen 12, various types of destination, various types of service or various predefined shipping companies that the user selects by using the input means 14.

As a function of the choices made by the user and of the weight indication transmitted by the weight sensors 9a or 9b, the management unit 11 computes the franking rate of the parcel that has just been deposited. The computed price is transmitted to the payment means 16 by means of which the user can pay the required sum by paying in coins or by smart card.

Once the payment has been made, the payment means 16 send a confirmation message to the management unit 11 which then considers that the parcel has been franked correctly. As soon as this confirmation message is received, the management unit causes the lock 4 to go to the locked position and the parcel is thus kept completely securely inside the locker 2 until it is withdrawn by the shipping company.

It should be noted that the locker could be locked before the payment is confirmed and even as soon as the door is closed by the user. However, it is advantageous to provide a possibility of canceling the franking operation that is particularly simple and intuitive for the user. To this end, provision is made so that, if the management unit 11 receives information from the position detector of the door of the locker in question, indicating that said door is open, the franking operation is interrupted.

Thus, the trust of the user in the franking apparatus is increased, because the user continues to be able to retrieve the parcel until the payment operation is complete. In addition, there is no automatic handling of the parcel in the apparatus, thereby further increasing said trust.

After the door of the locker has been locked, and if the user so wishes, the print means 18 print out a ticket. The ticket bears an indication attesting to the fact that the user has paid the franking price, and any other relevant information for confirming that a parcel has been deposited and for tracking said parcel. For example, said other information can comprise the date and the time of deposition, the choices of destination and the type of shipping, the numbers of the franking apparatus and of the locker used, and the weight of the parcel as measured by the franking apparatus.

Once the franking operation is finished, it is possible for the management unit 11 to cause a communications operation to take place in order to notify the shipping company in question that a parcel has just been franked for it.

However, the communications operation can also be performed at set times that are different for each of the shipping companies, and sufficiently early so that said shipping companies can cancel the retrieval operation if there are no parcels for it to collect.

Naturally, it is also possible to make provision for it to be the shipping company that interrogates the parcel deposit apparatus from its remote site 28 before going on its parcel collection round.

In order to retrieve the parcels, a given shipping company sends an employee equipped with a barcode badge that is recognized by the management unit by means of the barcode reader 15. A retrieval code of a predefined shipping company or of an employee of that company being recognized by means of the barcode or of any other identity means, such as, for example, an electromagnetic transponder, triggers opening by the management unit 11 of the lockers whose contents are associated with said company in the memory table 23. It is possible to make provision for said lockers to be opened simultaneously. However, if members of the public are present in the vicinity of franking apparatus, it is preferable to make provision for the lockers to be opened in succession, which can be achieved automatically either by means of the position detectors 5 of the doors, or by means of the weight sensors (9a, 9b).

By means of the position detectors 5 of the doors, the management unit 11 can cause the parcel retrieval operation to take place in the following steps:

the management unit 11 opens a first locker from among the lockers containing parcels to be collected by said shipping company;

the management unit waits for information indicating that the door of the first locker is in the open position, meaning that the parcel is accessible for the employee of the shipping company; followed by

waiting for information indicating that the door of said first locker is closed, both meaning that the first parcel has been removed and also obliging the doors of the franking apparatus to be closed again; and then

unlocking the door of a second locker from among the lockers containing parcels to be fetched by said company, and so on to the last locker.

By using the weight sensors (9a, 9b), the management unit can cause the parcel retrieval operation to take place by causing the following steps to take place:

unlocking the door of a first locker from among the lockers containing parcels to be fetched by said shipping company; followed by

waiting for transmission of a weight indication that indicates that the weight of the contents of said locker is substantially zero, and then

unlocking a second locker from among said lockers, and so on to the last one of said lockers.

It is apparent to the person skilled in the art that these two parcel retrieval methods can be combined for ensuring both that each locker door is closed again and that the parcel placed inside a locker has indeed been retrieved by the employee of the shipping company.

During the retrieval operation, i.e. after the management unit has recognized a retrieval code, it is advantageous for provision to be made for franking labels to be printed for the parcel(s) that are to be retrieved.

The labels are in the form of adhesive stickers printed by the print means 18. Various items of information can appear on the labels, such as, for example, a reference associated with the parcel, the franking price paid, the shipping company and the shipping service chosen by the user, and the destination indicated by the user during the franking operation. Said labels, which are affixed to the parcels by the employee of the shipping company on retrieving said parcels, make it possible for shipment to be tracked and also for it to be verified whether the indication of the destination given by the user does indeed correspond to the address that the user affixed to the parcel before it was franked.

When a plurality of parcels are to be retrieved, it is possible for the printing out of the labels to be synchronized with successive and automatic unlocking of the corresponding lockers, in order to prevent labels for different parcels from being muddled up.

The embodiment described is no way limiting, and it is quite possible to arrange the sensors (9a, 9b), the detectors 5 or the means 12 to 16 differently than as shown in the figures, or indeed to provide additional steps for implementing the franking apparatus of the invention.

1. Parcel-franking apparatus, characterized in that it comprises:
a plurality of lockers (2) designed to contain parcels and each provided with a door (3);
a management unit (11);
locks (4) each adapted to lock a respective door and each controlled individually by the management unit;
door position detectors (5), each associated with a respective door and adapted to inform the management unit when the corresponding door is closed;
at least one weight sensor (9a, 9b) adapted to transmit to the management unit an indication of the weight of a parcel placed in one or other of the lockers; and
display means (12), data input means (14), and payment means (16), all these means being connected to the management unit;
and characterized in that the management unit (11) is adapted:
to compute a franking price for franking a parcel placed in a determined locker on the basis of the data delivered by the input means (14), and of the indication of the weight of said parcel as transmitted by the weight sensor (9a, 9b), when a position detector (5) associated with a door (3) of said determined locker (2) detects that the door is closed;
to cause the door of said locker to be locked once the computed franking price has been paid; and
to keep the door of said locker locked until the management unit recognizes a parcel retrieval code which has been delivered to it by the data input means.

2. Parcel-franking apparatus according to clam 1, wherein the management unit (11) includes memory means (22) adapted to store tables of franking rates corresponding to various types of destinations and/or to various types of shipping services, the management unit being adapted to compute the franking price by means of a rate selected from the data delivered by the input means (14).

3. Parcel-franking apparatus according to claim 1 or 2, wherein the management unit (11) includes memory means (23) adapted to store a plurality of predetermined shipping companies and a table associating a determined locker with a predefined shipping company, the management unit being adapted to record the association of a particular locker (2) with a predefined shipping company on the basis of the data delivered by the input means (14).

4. Parcel-franking apparatus according to claim 3, wherein the management unit (11) is adapted to cause the doors (3) of all of the lockers (2) associated with a predefined shipping company to be unlocked, once a retrieval code transmitted by the data input means (14) has been recognized.

5. A method of implementing parcel-franking apparatus according to claim 1, said method comprising a franking operation, in which method the franking operation comprises the following steps:
waiting for information indicating that the door of a determined locker (2) is closed; then
computing a franking price for franking a parcel placed in said determined locker on the basis of the data delivered to the input means (14) and by means of the indication of the weight of said parcel as transmitted by the weight sensor (9a, 9b); then
paying the franking price as previously computed; and
locking the door of said determined locker.

6. A method according to claim 5, wherein the franking operation further comprises, prior to the step of waiting for a closed signal:
selecting the determined locker (2) from among the available lockers by the management unit (11); then
unlocking the lock (4) of said determined locker by the management unit (11).

7. A method according to claim 5 or claim 6, wherein the management unit (11) is provided with memory means (22) adapted to store tables of franking rates corresponding to different types of destination and/or to different types of shipping services, and wherein the computing step of the franking operation further comprises at least one of the following sub-steps:
displaying various types of destination stored by the management unit, followed by using the input means (14) to select a type of destination, and applying the corresponding franking rate to computation of the franking price; and
displaying various types of destination stored by the management unit, followed by using the input means (14) to select a type of shipping service and applying the corresponding franking rate to computation of the franking price.

8. A method according to any one of claims 5 to 7, wherein the management unit is provided with memory means (23) adapted to store a plurality of predefined shipping companies and a table associating a determined locker with a predefined shipping company, and in which the franking operation further comprises the following step:
displaying various predefined shipping companies, followed by using the input means (14) to select a predefined shipping company, and associating said company with the determined locker.

9. A method according to any one of claims 5 to 8, wherein the franking operation further comprises, between the waiting step for waiting for information indicating that the door (3) of the determined locker (2) is closed and the locking step for locking said door that follows the payment step for paying for the franking price, a step consisting in:
interrupting the franking operation in the event that the position detector (5) issues information indicating that said door is open.

10. A method according to any one of claims 5 to 9, wherein the management unit (11) is provided with memory means (23) which are adapted to store a table associating at least one locker (2) with at least one predefined shipping company, and in which a retrieval operation is also provided for retrieving at least one parcel, said retrieval operation comprising the following steps:
recognizing a retrieval code associated with the predefined shipping company by the management unit (11); and
opening said at least one locker (2) associated with said shipping company.

11. A method according to claim 10, wherein the retrieval operation further comprises, after the recognition step for recognizing a retrieval code, the following step:
printing at least one franking label for the parcel contained in said at least one locker.

12. A method according to claim 10 or claim 11, wherein the contents of a plurality of lockers (2) are associated with the same shipping company, and wherein the retrieval operation for retrieving the parcels further comprises, after the recognition step for recognizing a code associated with said shipping company, the following steps:
unlocking the door (3) of a first one of said lockers (2);
waiting for information indicating that the door of the first one of said lockers is in the open position; followed by:
waiting for information indicating that the door of said first one of said lockers is closed; then
unlocking the door of a second one of said lockers (2).

13. A method according to claim 10 or 11, wherein the contents of a plurality of lockers (2) are associated with the same shipping company, and wherein the retrieval operation for retrieving the parcels further comprises, after the recognition step for recognizing a code associated with said shipping company, the following steps:
unlocking the door (3) of a first one of said lockers (2);
waiting for the weight sensor (9a, 9b) to transmit a weight indication indicating that the weight of the contents of the first one of said lockers is substantially zero; then
unlocking the door of a second one of said lockers (2).
